(19) United States
(12) Patent Application Publication
(10) Pub. No.: US 2016/0178907 A1
(43) Pub. Date: Jun. 23, 2016

(54) HEAD-MOUNTED ELECTRONIC DEVICE AND DISPLAY THEREOF

(71) Applicant: HTC Corporation, Taoyuan City (TW)

(72) Inventors: Chih-Lin Chang, Taoyuan City (TW); Cheng Lo, Taoyuan City (TW); Chun-Hung Chen, Taoyuan City (TW)

(21) Appl. No.: 14/722,147

(22) Filed: May 27, 2015

Related U.S. Application Data
(60) Provisional application No. 62/092,844, filed on Dec. 17, 2014.

(51) Int. Cl. G02B 27/01; G02B 5/02

(52) U.S. Cl. CPC G02B 27/0172; G02B 5/0242; G02B 5/0278; G02B 5/0231; G02B 2027/0118; G02B 2027/0178; G02B 2027/011

(57) ABSTRACT

The disclosure provides a display of a head-mounted electronic device suitable for displaying image information to a user in a space formed by the head-mounted electronic device and a head of the user when the head-mounted electronic device is mounted on the user's head. The display includes a display panel and a light adjusting element. The display panel has a display region for displaying the image information. The light adjusting element is disposed on the display region to change a direction of light emitted from the display panel, so as to mitigate the screen-door effect and improve the displaying quality of the display.

### CROSS-REFERENCE TO RELATED APPLICATION

This application claims the priority benefits of U.S. provisional application Ser. No. 62/092,844, filed on Dec. 17, 2014. The entirety of the above-mentioned patent application is hereby incorporated by reference herein and made a part of this specification.

### BACKGROUND OF THE INVENTION

1. Field of the Invention

The disclosure is related to a display, and particularly related to a display of a head-mounted electronic device.

2. Description of Related Art

Recently, the technology of display panel has become matured and the technology is thus applied more and more broadly. The displays used with TVs and desktop computers, the laptop computers, the desktop computers, or even the recently emerging wearable electronic devices all use display panels as the display interface to output information.

Taking the head-mounted display for example, such display is usually configured in the faun of eye shield or helmet, and the display panel is set to be close to the user's eye, so as to display image information at a distance close to the user's eye. Since the display panel is very close to the user's eye, the boundary of pixels on the display panel becomes very obvious. In other words, as shown in FIG. 1, when a display panel 100 displays a picture 102, a screen-door effect due to edges 110 of pixels on the displayed image becomes significant. In particular, when the display panel includes a black matrix (BM) or wirings, the effect becomes even more significant.

### SUMMARY OF THE INVENTION

The disclosure provides display of a head-mounted electronic device capable of mitigating a screen-door effect of a displayed image, so as to improve a display quality.

When a head-mounted electronic device is mounted on a user's head, a display of the disclosure is suitable to display image information in a space formed by the head-mounted electronic device and the user's head. The display includes a display panel and a light adjusting element. The display panel has a display region for displaying the image information. The light adjusting element is disposed on the display region to change a direction of light emitted by the display panel to mitigate a screen-door effect.

The disclosure provides a head-mounted electronic device using the display capable providing a preferable visual effect to the user by improving the display quality.

The head-mounted electronic device of the disclosure includes a holder and the display. The holder is suitable to be mounted to a user's head, so as to form a space with the user's head. The display is disposed on the holder and suitable to display image information to the user in the space.

Accordingly, in the disclosure, the light adjusting element, such as a diffuser or a prism structure, is disposed on the display region of the display panel, such that light emitted by the display panel may pass through the light adjusting element before arriving the user's eye. In this way, by using the light adjusting element to change the direction of light, the light may reach the user's eye after being refracted, scattered, or reflected by the light adjusting element, for example, so as to mitigate the screen-door effect caused by a pixel structure and thereby improve the display quality of the display.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a conventional display panel displaying image information.

FIG. 2A is a schematic view illustrating a head-mounted electronic device according to an embodiment of the disclosure.

FIG. 2B is another view of the head-mounted electronic device of FIG. 2A.

FIG. 2C is a schematic view illustrating the head-mounted electronic device of FIG. 2A mounted on the user's head.

FIG. 3 is a view illustrating a specific structure of the display of FIG. 2B.

FIG. 4 is a schematic view comparing whether a diffuser is disposed or not disposed when the display of FIG. 3 displays image information.

FIGS. 5A and 5B are views respectively illustrating how a diffuser is fully adhered to a display panel.

FIG. 6 is a view illustrating a diffuser according to an embodiment of the disclosure.

FIG. 7A is a view illustrating a display according to another embodiment of the disclosure.

FIG. 7B is a cross-sectional view illustrating the display shown in FIG. 7A along a line A-A′.

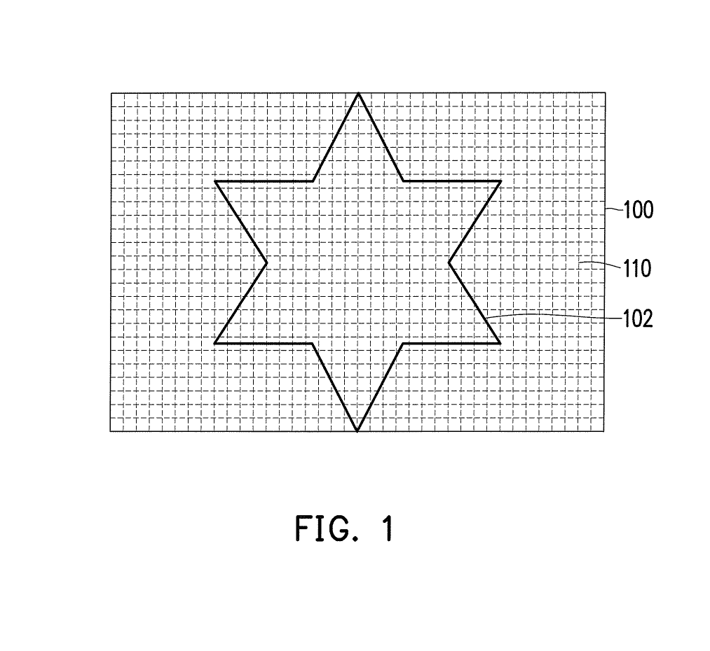

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

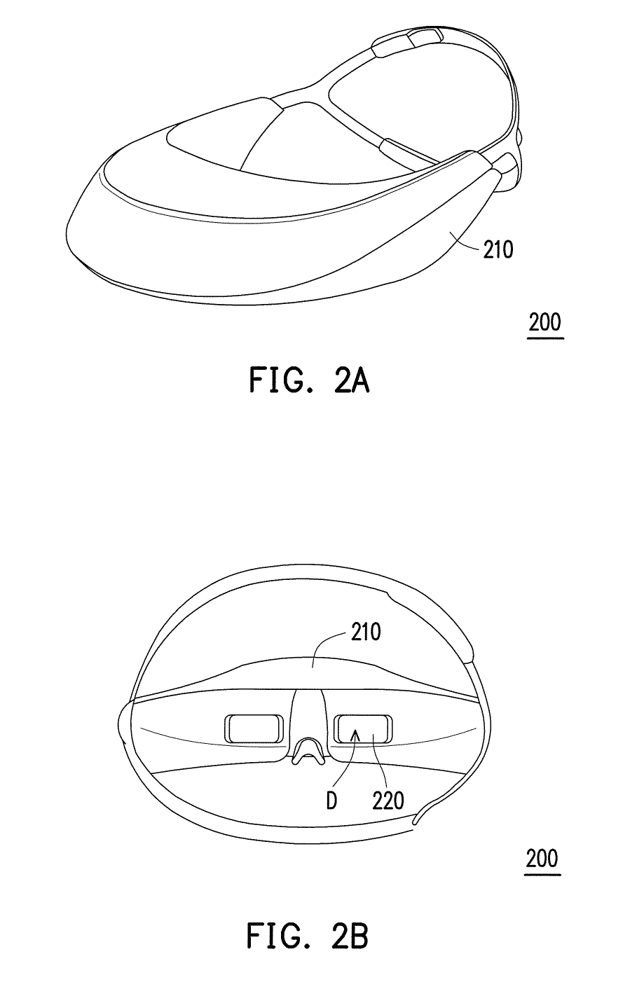

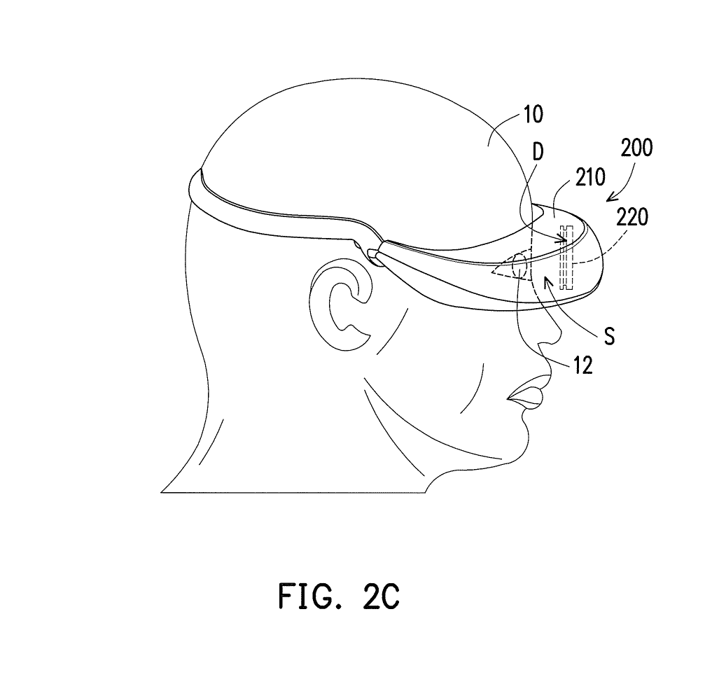

FIG. 2A is a schematic view illustrating a head-mounted electronic device according to an embodiment of the disclosure. FIG. 2B is another view of the head-mounted electronic device of FIG. 2A. FIG. 2C is a schematic view illustrating the head-mounted electronic device of FIG. 2A mounted on the user's head. As shown in FIGS. 2A to 2C, a head-mounted electronic device 200 includes a holder 210 and a display 220. The holder 210 may be in any possible faun and is configured to carry the display 220. In addition, the holder 210 is fixed to the user's head 10. Possible forms of the holder 210 include an eye shield, a helmet, or any design that may be fixed to the user's head 10. In addition, when the holder 210 of this embodiment is mounted to the user's head, the head-mounted electronic device 200 and the user's head 10 form a space S. It is difficult for external light to pass through the space S and enter the user's eye to influence the user to view image information displayed by the display 220. If the space S is an enclosed space, and the external light is unable to enter the space S, the display 220 is able to provide a preferable visual effect to the user. At this time, a display region D of the display 220 and the user's eye 12 are located in the space S at the same time. The user may directly view the image information displayed in the display region D of the display 220 through the eye 12.

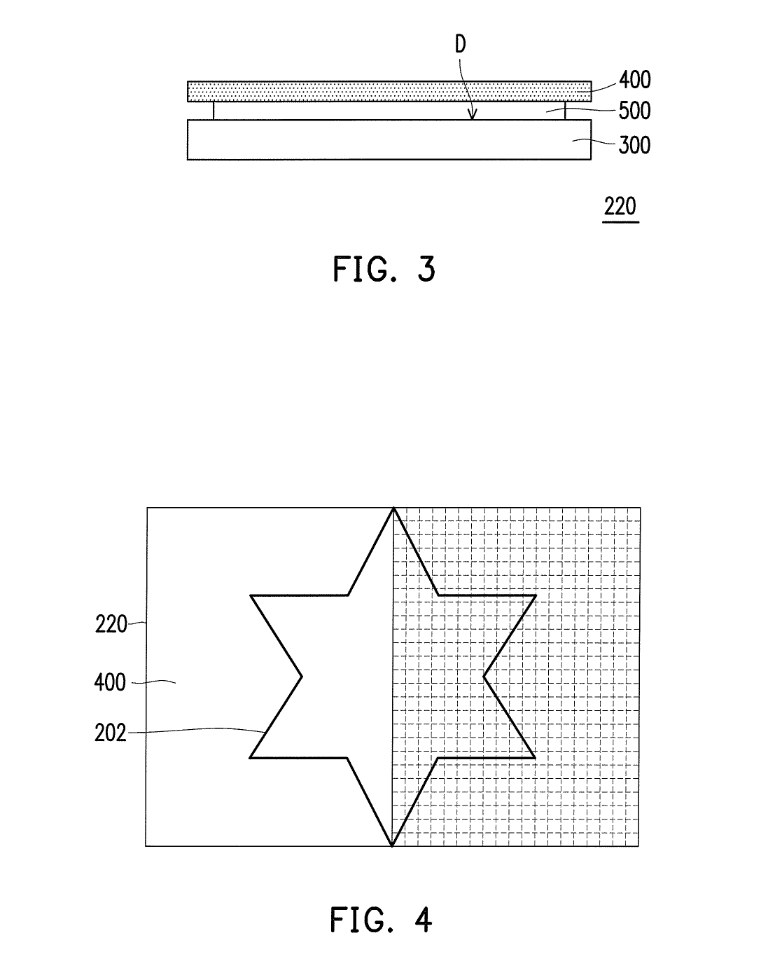

FIG. 3 is a view that further illustrates a specific structure of the display 220. Referring to FIGS. 2A to 2C and FIG. 3 together, the display 220 of this embodiment includes a display panel 300 and a light adjusting element (e.g., a diffuser 400). In addition, the display panel 300 provides the display region D for displaying the image information. Also, the diffuser 400 as the light adjusting element is disposed on the display region D. Thus, light emitted when the display panel 300 displays the image information may pass through the diffuser 400, and may reach the user's eye 12 after being refracted or scattered by the diffuser 400. In other words, the user's eye 12 may not (or is unlikely to) see a region that does not emit light, such as edges of pixels (e.g., black matrix or wirings). In this way, through refraction or scattering of light, a screen-door effect caused by the edges of pixels when the display panel 300 displays the image information may be mitigated.

FIG. 4 is a schematic view comparing whether the diffuser 400 is disposed or not disposed when the display 220 of this embodiment display a picture 202. As shown in FIG. 4, the left side of the display 220 demonstrates a display effect when the diffuser 400 is disposed, while the right side of the display 220 demonstrates a display effect when the diffuser 400 is not disposed. Here, the screen-door effect at the left side of the display 220 where the diffuser 400 is disposed is mitigated, and a mesh in the picture 202 displayed by the display 220 is less significant.

As shown in FIG. 3, the display panel 300 of this embodiment is a liquid crystal display panel or an organic light emitting diode display panel, for example. In addition, the diffuser 400 is adhered onto the display panel 300 through an adhesive layer 500, for example. In addition, the adhesive layer 500 covers the entire display region D, making the diffuser 400 fully adhered to the display region D. The adhesive layer 500 may be a semi-cured adhesive, such as an optically clear adhesive (OCA), or other transparent gels, such as liquid glue.

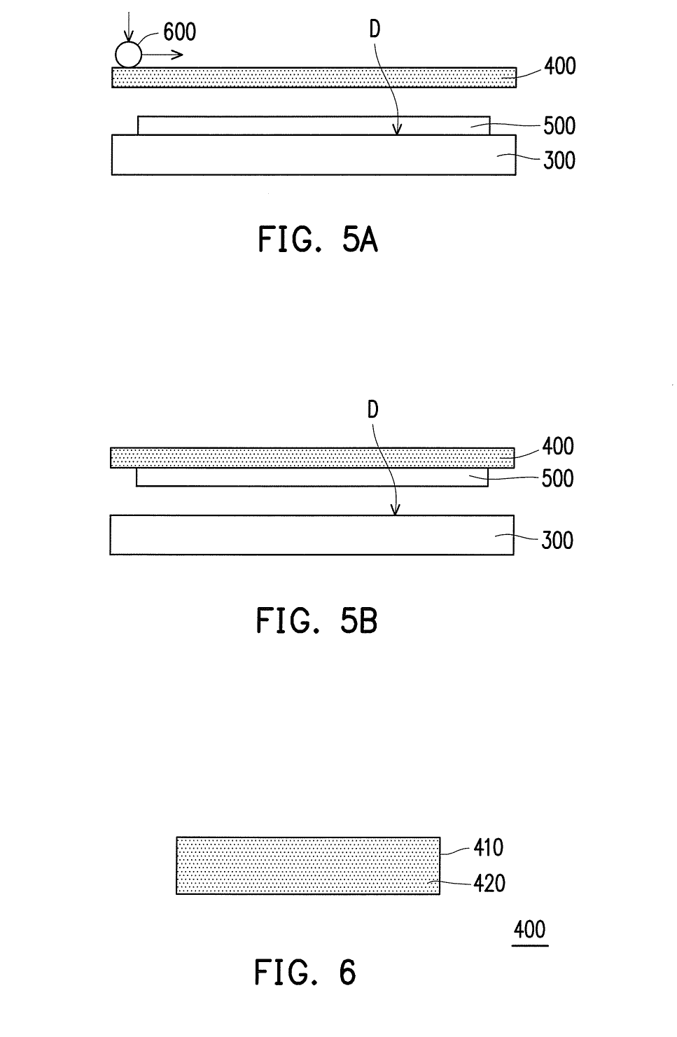

FIGS. 5A and 5B illustrates two configurations where the diffuser 400 is fully adhered to the display region D of the display panel 300 by using the adhesive layer 500.

As shown in FIG. 5A, the adhesive layer 500 may be formed on the display panel 300. Then, the diffuser 400 is placed on the adhesive layer 500, and a roller 600 is used to laminate the diffuser 400 and the display panel 300. Alternatively, as shown in FIG. 5B, the display panel 300 and the diffuser 400 with the adhesive layer 500 may be placed in a vacuum environment together, such that the display panel 300 and the diffuser 400 are adhered to each other through the adhesive layer 500.

It should be noted that, as shown in FIG. 3, using the semi-cured adhesive layer 500 helps maintain a gap between the diffuser 400 and the display region D of the display panel 300. In this way, relative positions between the diffuser 400 and the display panel 300 may be controlled accurately, so as to obtain a preferable light-refracting or light-scattering effect. Besides, since the adhesive layer 500 fills into the gap between the diffuser 400 and the display panel 300, a loss of light due to refraction of reflection when the light is transmitted between different interfaces may be reduced. More specifically, compared with a design where an air gap is between the diffuser 400 and the display panel 300, the adhesive layer 500 having a refractive index between those of air and the display panel 300 (or the diffuser 400) is chosen in this embodiment. Thus, the refraction and reflection of light between different interfaces may be reduced, thereby reducing the loss of light. Generally speaking, compared with the design where the air gap is between the diffuser 400 and the display panel 300, when an optically clear adhesive is used as the adhesive layer 500 in this embodiment, an overall display brightness of the display 200 may increase by 8% or more.

Of course, in other embodiments, the screen-door effect may still be mitigated even if the diffuser 400 and the display panel 300 are not adhered.

Also, FIG. 6 illustrates the diffuser 400 including a transparent substrate 410 and a plurality of scattering particles 420 distributed in the transparent substrate 410. A refractive index of the scattering particles 420 is different from a refractive index of the transparent substrate 410.

However, the disclosure does not intend to impose a limitation on possible configurations of the light adjusting element. Any optical element (e.g., prism, lens, reflector, etc.) that is able to generate the effects of light refraction, scattering, reflection, etc., and change a direction of light may serve as the light adjusting element to a reasonable extent, so as to offer an identical or similar effect. For example, in other embodiments, a microstructure or a prism structure may be manufactured on the transparent substrate to replace the diffuser 400.

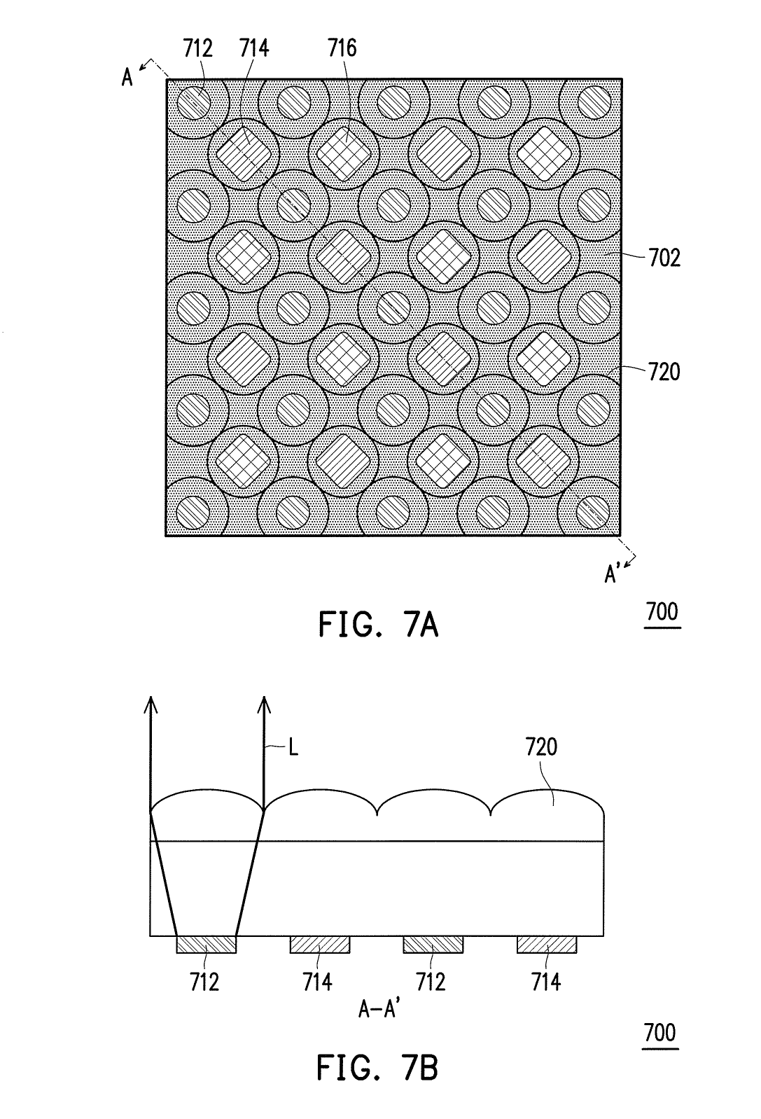

FIG. 7A is a view illustrating a display according to another embodiment of the disclosure. FIG. 7B is a cross-sectional view illustrating the display shown in FIG. 7A along a line A-A′. As shown in FIGS. 7A and 7B, a prism structure may be used in the disclosure to replace the diffuser 400 in the previous embodiment. More specifically, a display panel 700 of this embodiment includes a plurality of pixels 712, 714, and 716 of different colors defined by a black matrix 702. In this embodiment, a plurality of prism structures 720 is manufactured on a surface of the display panel 700. In addition, positions of the prism structures 720 respectively correspond the pixels 712, 714, and 716, such that light L emitted by the pixels 712, 714, and 716 may reach the user's eye 12 (as shown in FIG. 2C) after passing through the corresponding prism structures 720. In other words, through refraction of light, the user's eye 12 does not (or is not likely to) see the region that does not emit light, such as the edges of pixels (e.g., black matrix or wirings). In this way, the screen-door effect caused by the edges of pixels when the display panel 700 displays the image information may be mitigated.

In view of the foregoing, the light adjusting element, such as the diffuser or prism structure, is disposed on the display region of the display panel in the head-mounted electronic device provided in the disclosure. In this way, the light emitted by the display panel passes through the light adjusting element before arriving the user's eye. In this way, the direction of light is changed. When the head-mounted electronic device is mounted on the user's head, the display displays the image information to the user in the space formed by the head-mounted electronic device and the user's head. In the environment without entry and interference of the external light, the image information displayed by the display panel is transmitted to the user's eye through the light adjusting element. Thus, through the optical effect such as refraction, scattering, and reflection provided by the light adjusting element, the screen-door effect caused by the edges of pixels is mitigated. Thus, the quality of the image information viewed by the user is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display for a head-mounted electronic device, suitable for displaying image information to a user in a space formed by the head-mounted electronic device and the user's head, the display comprising:
a display panel, having a display region and configured to display the image information; and
a light adjusting element, disposed on the display region, wherein the light adjusting element changes a direction of light emitted by the display panel to mitigate a screen-door effect.

2. The display as claimed in claim 1, wherein the light adjusting element comprises a diffuser disposed on the display region.

3. The display as claimed in claim 2, further comprising an adhesive layer located between the diffuser and the display region and covering the entire display region to adhere the diffuser to the display region.

4. The display as claimed in claim 3, wherein the adhesive layer is a semi-cured adhesive.

5. The display as claimed in claim 2, wherein the diffuser comprises a transparent substrate and a plurality of scattering particles distributed in the transparent substrate.

6. The display as claimed in claim 1, wherein the light adjusting element comprises a plurality of prism structures disposed on the display region.

7. The display as claimed in claim 1, wherein the display panel is a liquid crystal display panel or an organic light emitting diode display panel.

8. A head-mounted electronic device, comprising:
a holder, suitable to be mounted to a user's head, so as to form a space with the user's head;
a display, disposed on the holder and suitable to display image information to the user in the space, the display comprising:
a display panel, having a display region and configured to display the image information; and
a light adjusting element, disposed on the display region, wherein the light adjusting element changes a direction of light emitted by the display panel to mitigate a screen-door effect.

9. The head-mounted electronic device as claimed in claim 8, wherein the light adjusting element comprises a diffuser disposed on the display region.

10. The head-mounted electronic device as claimed in claim 9, wherein the display further comprises an adhesive layer located between the diffuser and the display region and covering the entire display region to adhere the diffuser to the display region.

11. The head-mounted electronic device as claimed in claim 10, wherein the adhesive layer is a semi-cured adhesive.

12. The head-mounted electronic device as claimed in claim 9, wherein the diffuser comprises a transparent substrate and a plurality of scattering particles distributed in the transparent substrate.

13. The head-mounted electronic device as claimed in claim 9, wherein the light adjusting element comprises a plurality of prism structures disposed on the display region.

14. The head-mounted electronic device as claimed in claim 8, wherein the display panel is a liquid crystal display panel or an organic light emitting diode display panel.
